(19) United States
(12) Patent Application Publication
(10) Pub. No.: US 2026/0133949 A1
(43) Pub. Date: May 14, 2026

(54) ELIMINATING REDUNDANT EMBEDDINGS GENERATION USING HIERARCHICAL METADATA AND VECTOR TRUTH TABLES

(71) Applicant: View Systems, Inc., Dover, DE (US)

(72) Inventors: Keith Barto, Pine, CO (US); Blake Martz, San Diego, CA (US); Joel Christner, El Dorado Hills, CA (US); Yipeng Li, Campbell, CA (US)

(73) Assignee: View Systems, Inc., Dover, DE (US)

(21) Appl. No.: 19/379,533

(22) Filed: Nov. 4, 2025

Related U.S. Application Data
(60) Provisional application No. 63/719,590, filed on Nov. 12, 2024.

(51) Int. Cl. G06F 16/22

(52) U.S. Cl. CPC G06F 16/2237

(57) ABSTRACT

This disclosure provides methods, devices, and systems for generating vector embeddings. The present implementations more specifically relate to detecting changes in a data asset for targeted embeddings generation. For example, a data processing pipeline may receive a data asset to be converted to a set of vector embeddings. In some aspects, the data processing pipeline may map the data asset to one or more hash values and create a user table for the data asset based at least in part on the one or more hash values, where the user table includes one or more pointers that point to one or more records stored in a vector repository, respectively, where each record of the one or more records includes a vector embedding and a hash value associated therewith that matches a respective hash value of the one or more hash values.

### CROSS-REFERENCE TO RELATED APPLICATIONS

This application claims priority and benefit under 35 U.S.C. § 119(e) to U.S. Provisional Patent Application No. 63/719,590, filed Nov. 12, 2024, which is incorporated herein by reference in its entirety.

### TECHNICAL FIELD

This disclosure relates generally to vector embeddings, and specifically to eliminating redundant embeddings generation using hierarchical metadata and vector truth tables.

### DESCRIPTION OF RELATED ART

Many businesses store and use data of various types (including structured data and unstructured data), each having its own layout and semantics configured for the applications and/or users producing or consuming the data. Some businesses may benefit by leveraging such data assets as a means of yielding business insights (such as analytics) or creating transformative experiences, such as those provided through machine learning. Machine learning (also referred to as “artificial intelligence” or “AI”) is a technique for improving the ability of a computer system or application to perform a certain task. Machine learning can be generally broken down into two component parts: training and inferencing. During the training phase, a machine learning system is provided with one or more “answers” and a large volume of raw training data associated with the answers. The machine learning system analyzes the training data to learn a set of rules (also referred to as a machine learning “model”) that can be used to describe each of the answers. During the inference phase, the machine learning system may infer answers from new data using the learned set of rules.

Deep learning is a particular form of machine learning in which the inferencing and training phases are performed over multiple layers. Deep learning architectures are often referred to as “artificial neural networks” due to the manner in which information is processed (similar to a biological nervous system). For example, each layer of an artificial neural network may be composed of one or more “neurons.” Each layer of neurons may perform a different transformation on the output data from a preceding layer so that the final output of the neural network results in the desired inferences. The set of transformations associated with the various layers of the network is referred to as a “neural network model.” Example suitable neural networks include convolutional neural networks (CNNs), recurrent neural networks (RNNs), long short-term memory (LSTM) networks, and transformers, among other examples.

Many neural networks are designed to process vectorized data, also referred to as “embeddings.” An embedding is a numerical vector, in any high-dimensional space, having a magnitude and direction that represents a real-world object (such as a word) or set of objects (such as a sentence, paragraph, or other grouping of words). The mapping between objects and embeddings is defined by the neural network model used to process the embeddings. In other words, different neural network models may map the same object to different vector embeddings (which may reside in different multidimensional spaces). However, the generation and storage of embeddings is resource intensive and time consuming, which can be cost-prohibitive for some businesses and create material delays in the data processing pipelines for AI applications. Thus, there is a need to reduce the overhead (such as time and resource requirements) associated with vectorizing data for neural network processing.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method for processing data. The method includes steps of receiving a first data asset; mapping the first data asset to one or more first hash values; and creating a first user table for the first data asset based at least in part on the one or more first hash values, where the first user table includes one or more pointers that point to one or more records stored in a vector repository, respectively, where each record of the one or more records pointed to by the first user table includes a vector embedding and a hash value associated therewith that matches a respective hash value of the one or more first hash values.

Another innovative aspect of the subject matter of this disclosure can be implemented in a data processing pipeline, including a processing system and a memory. The memory stores instructions that, when executed by the processing system, cause the data processing pipeline to receive a first data asset; map the first data asset to one or more first hash values; and create a first user table for the first data asset based at least in part on the one or more first hash values, where the first user table includes one or more pointers that point to one or more records stored in a vector repository, respectively, where each record of the one or more records pointed to by the first user table includes a vector embedding and a hash value associated therewith that matches a respective hash value of the one or more first hash values.

### BRIEF DESCRIPTION OF THE DRAWINGS

The present implementations are illustrated by way of example and are not intended to be limited by the figures of the accompanying drawings.

FIG. 1 shows a block diagram of an example data orchestration system, according to some implementations.

FIG. 2 shows a block diagram of an example data processing pipeline, according to some implementations.

FIG. 3A shows an example truth table for storing vector embeddings, according to some implementations.

FIG. 3B shows an example set of truth tables for storing vector embeddings, according to some implementations.

FIG. 4 shows an example user table for aggregating embeddings associated with a data asset, according to some implementations.

FIG. 5A shows an example data asset.

FIG. 5B shows example metadata that can be extracted from the data asset of FIG. 3A, according to some implementations.

FIG. 6A shows another example data asset.

FIG. 6B shows example metadata that can be extracted from the data asset of FIG. 4A, according to some implementations.

FIG. 7A shows an example relational database including a truth table and a user table, according to some implementations.

FIG. 7B shows an example relational database including a truth table and multiple user tables, according to some implementations.

FIG. 8 shows a block diagram of an example data processing pipeline, according to some implementations.

FIG. 9 shows an illustrative flowchart depicting an example operation for processing data, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example systems or devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described herein. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, or executed by a computer or other processor.

The various illustrative logical blocks, modules, circuits and instructions described in connection with the implementations disclosed herein may be executed by one or more processors (or a processing system). The term “processor,” as used herein may refer to any general-purpose processor, special-purpose processor, conventional processor, controller, microcontroller, or state machine capable of executing scripts or instructions of one or more software programs stored in memory.

As described above, “embeddings” are numerical vectors representing real-world objects (such as words) or sets of objects (such as sentences, paragraphs, or other groupings of words) that can be provided as inputs to neural networks for training and inferencing purposes. More specifically, a data asset (such as a slideshow presentation, word processing document, or structured query language (SQL) database) must be converted or “mapped” to a set of embeddings before it can be processed through the layers of a neural network. Thus, the terms “embedding,” “vectors,” and “vector embeddings” may be used herein interchangeably. For many AI applications (such as retrieval augmented generation (RAG)), the data asset being processed by the neural network is often an updated or revised version of another data asset previously processed by the same neural network (such as a revised draft of the same document or file). Existing AI data processing pipelines are designed to generate embeddings for each new data asset, in its entirety, even if only a portion of the data asset has changed from a previous version of the data asset. Aspects of the present disclosure recognize that the overhead associated with generating embeddings can be significantly reduced by reusing embeddings for portions of a data asset that remain unchanged from previous versions of the data asset and storing the embeddings in a truth table that can be referenced by multiple user tables.

Various aspects relate generally to systems and techniques for generating vector embeddings, and more particularly, to detecting changes in a data asset for targeted embeddings generation. For example, a data processing pipeline may receive a data asset to be converted to a set of vector embeddings. In some aspects, the data processing pipeline may map the data asset to one or more hash values and compare the hash values to a lookup table. The lookup table stores known hash values associated with previously generated vector embeddings stored in a vector repository (or truth table). The data processing pipeline selectively maps the data asset to one or more vector embeddings based on whether the hash values match any of the known hash values in the lookup table. Specifically, the data processing pipeline may refrain from generating any new vector embeddings if each of the hash values matches a known hash value in the lookup table. In some implementations, the data processing pipeline may store a single instance of each unique embedding in a truth table (or set of truth tables) so that the same embeddings can be reused or otherwise accessed by multiple data repositories that store user data (also referred to as “user tables” or “knowledge bases”). For example, each user table may store one or more embedding identifiers (in lieu of embeddings themselves) that point to records in the truth table where the corresponding embeddings are stored.

Particular implementations of the subject matter described in this disclosure can be implemented to realize one or more of the following potential advantages. By mapping each data asset to one or more hash values and comparing them to known hash values associated with previously generated embeddings, aspects of the present disclosure can quickly detect changes or updates to the data asset that may require the generation of new embeddings. More specifically, the data processing pipeline of the present implementations can avoid generating redundant embeddings for data assets (or portions thereof) that remain unchanged from previous versions of the same data assets. For example, if the hash values associated with a new data asset match known hash values associated with previously generated embeddings, the data processing pipeline may retrieve and/or reuse such previous embeddings in the vector database rather than generate new embeddings for the new data asset. By storing a single instance of each embedding in a truth table (or set of truth tables) that can be referenced by multiple user tables, aspects of the present disclosure may further reduce the overhead associated with storing embeddings. For example, rather than storing multiple instances of the same embeddings across multiple user tables (which may consume a significant amount of storage space), each user table can instead point to a single centralized data repository that stores the embeddings for all user tables. Such truth tables not only prevent redundant storage of embeddings, but also provide greater insight into the embeddings themselves (such as which embeddings are reused and/or how often).

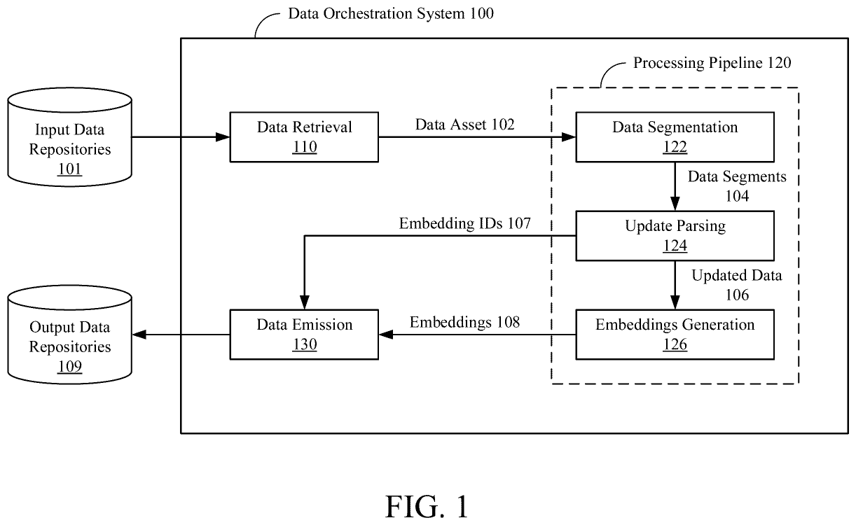

FIG. 1 shows a block diagram of an example data orchestration system 100, according to some implementations. The data orchestration system 100 is configured to retrieve data assets 102 from one or more input data repositories 101, convert each data asset 102 to a respective set of embeddings 108, and emit the resulting embeddings 108 to one or more output data repositories 109. A data asset 102 can be a document, file, or database of any type (such as images, videos, slideshow presentations, word processing documents, SQL databases, JavaScript Object Notation (JSON) files, and HyperText Markup Language (HTML) documents, among other examples). In some implementations, the output data repositories 109 may be different than the input data repositories 101. In some other implementations, the output data repositories 109 may be the same as the input data repositories 101.

The data orchestration system 100 includes a data retrieval component 110, a data processing pipeline 120, and a data emission component 130. The data retrieval component 110 is configured to communicate or interface with the input data repositories 101 to facilitate the retrieval of data assets 102. Example suitable input data repositories 101 include computers, servers, storage systems, and third-party platforms (such as software-as-a-service (SaaS) platforms), among other examples. In some implementations, the data retrieval component 110 may store information identifying the one or more input data repositories 101 from which the data assets 102 can be retrieved. In some implementations, the data retrieval component 110 may detect or identify the input data repositories 101 using network discovery tools (such as by querying Active Directory or performing port scans on the network).

The data emission component 130 is configured to communicate or interface with the output data repositories 109 to facilitate the storage or emission of the embeddings 108. Example suitable output data repositories 109 include computers, servers, storage systems, and/or third-party platforms that are connected or otherwise accessible to processing systems and/or applications configured to use or perform additional processing on the embeddings 108 (such as for analytics or machine learning). In some implementations, the data emission component 130 may store information identifying the one or more output data repositories 109 to which the embeddings 108 can be emitted and/or stored.

The data processing pipeline 120 is configured to perform a number of data operations that transform the data asset 102 into the embeddings 108. More specifically, the data processing pipeline 120 may process the data asset 102 according to one or more data objectives and/or requirements of a processing system or application (such as a machine learning model) intended to consume the data asset 102. In some implementations, the data processing pipeline 120 may store a set of discrete data operations that can be used to construct a data flow. A data flow defines the order in which the data operations are performed, including which specific steps are taken given a successful step, a failed step, or a step that encounters an unrecoverable exception. The data operations may include open-source and/or closed-source libraries that are configured to perform discrete tasks against the data. Example suitable tasks include loading data from a file or database, extracting text, stemming or lemmatizing the text, and merging the data, among other examples.

In the example of FIG. 1, the data processing pipeline 120 is shown to include at least a data segmentation component 122, an update parsing component 124, and an embeddings generation component 126. The data segmentation component 122 is configured to subdivide the data asset 102 into one or more data segments 104. In some implementations, the data segmentation component 122 may balance the granularity of the data segments 104 with the resource limitations of the data processing pipeline 120 and/or with the data objectives or requirements of the processing system or application intended to consume the data asset 102. For example, subdividing the data asset 102 into more data segments 104 of finer granularity may require more processing resources of the data processing pipeline 120 than subdividing the data asset 102 into fewer data segments 104 of coarser granularity.

The update parsing component 124 is configured to parse the data segments 104 for changes or updates compared to other data segments previously processed by the data processing pipeline 120 (also referred to as “previous data segments”). For example, the update parsing component 124 may compare each of the data segments 104 to a database of previous data segments and/or information associated therewith. In some implementations, the database may be a lookup table (LUT) that stores hash values associated with the previous data segments (in addition to, or in lieu of, the previous data segments). In such implementations, the update parsing component 124 may map each of the data segments 104 to a respective hash value based on a hash function associated with the LUT. Example suitable hash functions include Message-Digest Algorithm 5 (MD5), Secure Hash Algorithm 1 (SHA-1), and Secure Hash Algorithm 256-bit (SHA-256), among other examples.

In some aspects, the previous data segments may be mapped to embeddings that are stored in a vector repository (such as one of the output data repositories 109). In some implementations, the update parsing component 124 may output a respective embedding ID 107 for any data segment 104 that matches a previous data segment. For example, the embedding ID 107 may point to a respective record in the vector repository where an existing embedding is stored. In other words, the embedding ID 107 may be used to retrieve an embedding, from the vector repository, that maps to a given data segment 104. In this way, the update parsing component 124 may reuse embeddings from the vector repository for data segments 104 that have not been changed or updated (in lieu of generating new embeddings for the data segments). In some implementations, the update parsing component 125 may output one or more data segments 104, as updated data 106, if they do not match any previous data segments.

The embeddings generation component 126 is configured to generate new embeddings 108 for the updated data 106. As described above, an embedding is a mapping of any discrete (or categorical) variable to a vector of continuous numbers (such as a floating-point number) in a high-dimensional space. Thus, the process of generating embeddings is computationally intensive and time consuming. By generating new embeddings 108 only for the updated data 106, aspects of the present disclosure can significantly reduce the amount of time and resources used to transform data segments into embeddings. In some implementations, the data emission component 130 may store the new embeddings 108 in the vector repository and may generate a respective embedding ID 107 for each new embedding 108 indicating where the embedding 108 is stored. The data emission component 130 may further store the embedding IDs 107 (for new embeddings 108 and any reused embeddings indicated by the update parsing component 124) in an appropriate output data repository 109.

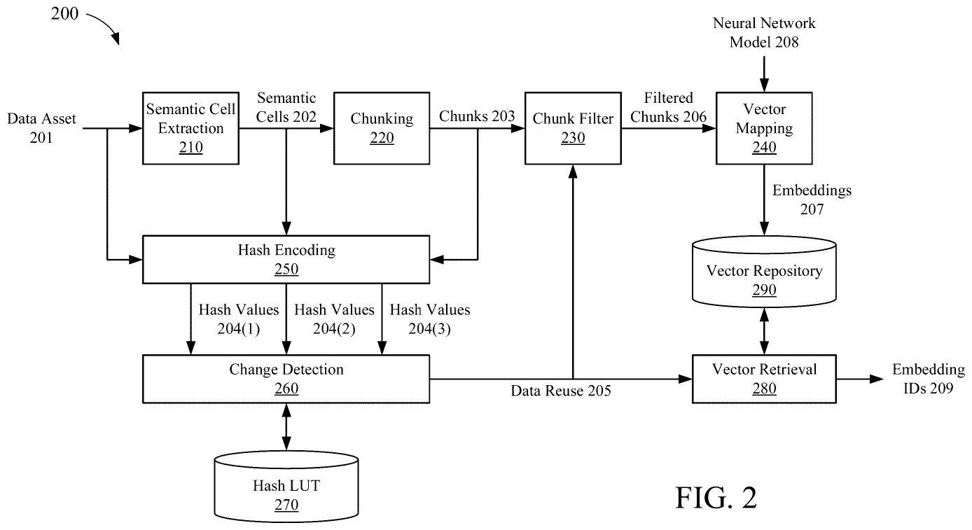

FIG. 2 shows a block diagram of an example data processing pipeline 200, according to some implementations. In some implementations, the data processing pipeline 200 may be one example of the data processing pipeline 120 of FIG. 1. More specifically, the data processing pipeline 200 is configured to produce a set of embedding IDs 209 for a data asset 201. With reference to FIG. 1, the data asset 201 may be one example of the data asset 102 and the embedding IDs 209 may be one example of the embedding IDs 107. In some implementations, each embedding ID 209 may point to, or otherwise identify, a respective embedding stored in a vector repository 290. For example, the embeddings may be associated with a neural network model 208. Thus, the data processing pipeline 200 is configured to prepare the data asset 201 to be processed or consumed by the neural network model 208.

Aspects of the present disclosure recognize that neural network models (including natural language processing (NLP) models and large language models (LLMs)) have predefined dimensionalities. In other words, a neural network model can only process and/or generate vector embeddings having a fixed size or dimension. As a result, the amount of input data represented by each vector embedding affects the fidelity of the neural network model. For example, mapping more input data to each vector embedding improves the efficiency of the training and/or inferencing operations but reduces the fidelity of the results. On the other hand, mapping less input data to each vector embedding sacrifices efficiency of the training and/or inferencing operations to improve the fidelity of the results. Thus, in some implementations, the data processing pipeline 200 may subdivide the data asset 201 into one or more data segments (such as the data segments 104 of FIG. 1) having a predetermined granularity based, at least in part, on the dimensionality of the neural network model 208. More specifically, the granularity of the data segments may balance the efficiency of the training and/or inferencing operations with the fidelity of the neural network model 208.

The data processing pipeline 200 includes a semantic cell extraction component 210, a chunking component 220, a chunk filter 230, a vector mapping component 240, a hash encoding component 250, a change detection component 260, and a vector retrieval component 280. The semantic cell extraction component 210 is configured to parse or arrange the data in the data asset 201 into one or more semantic cells 202. As used herein, the term “semantic cell” refers to a grouping of data that is semantically related. Example suitable semantic cells include sentences, paragraphs, pictures, and/or slides. A semantic cell can also be a “child” of another semantic cell (such as a sentence within a paragraph). The chunking component 220 is configured to arrange the data within each semantic cell 202 into even more granular chunks 203. As used herein, the term “chunk” refers to a subgrouping of data that is related to a given semantic cell. For example, chunks may be used to break down a semantic cell into smaller groups of data that can be processed more efficiently by a machine or computer (such as an LLM or NLP model) or yield more accurate and/or precise results.

The hash encoding component 250 is configured to map the data asset 201, the semantic cells 202, and the chunks 203 to hash values 204(1)-204(3) based on one or more hash functions. Example suitable hash functions include MD5, SHA-1, and SHA-256, among other examples. In some implementations, the hash encoding component 250 may generate and/or arrange the hash values 204(1)-204(3) in a hierarchical manner, so that the data asset 201 is mapped to a single hash value 204(1) at a top level of the hierarchy, the semantic cells 202 are mapped to respective hash values 204(2) in a middle level of the hierarchy, and the data chunks 203 are mapped to respective hash values 204(3) at a bottom level of the hierarchy. In some implementations, the hash encoding component 240 may use the same hash function to generate each of the hash values 204(1)-204(3). In some other implementations, the hash encoding component 240 may use different hash functions to generate different hash values 204(1), 204(2), and/or 204(3). For example, the hash value 204(1) may be associated with a first hash function, the hash values 204(2) may be associated with a second hash function, and the hash values 204(3) may be associated with a third hash function.

Still further, in some implementations, the hash encoding component 240 may use multiple hash functions to generate the hash values 204(1)-204(3). For example, the hash encoding component 240 may map the data asset 201 to multiple hash values 204(1) each associated with a different hash function (such as a combination of MD5, SHA-1, and/or SHA-256). Generating multiple hash values associated with different hash functions adds redundancy for detecting changes to the data asset 201, the semantic cells 202, and/or the data chunks 203 (so that the data processing pipeline 200 can detect duplicate or redundant data with greater certainty), while also providing greater flexibility for optimizing the performance of the data processing pipeline 200. For example, the data processing pipeline 200 may be programmed or otherwise instructed to use the hash values associated with a given hash function based on whether speed (MD5) or accuracy (SHA-256) is more important for the data objectives of the data processing pipeline 200 at any given time.

The change detection component 260 is configured to compare the hash values 204(1)-204(3) to a hash lookup table (LUT) 270 to determine which (if any) of the data chunks 203 match previously generated vector embeddings that can be reused by the data processing pipeline 200. For example, the hash LUT 270 may store a number of “known” hash values that were previously generated by the data processing pipeline 200 (such as for previously processed data assets 201). Accordingly, each of the known hash values is associated with one or more vector embeddings previously generated or otherwise output by the data processing pipeline 200. In some implementations, the change detection component 260 may compare each of the hash values 240(1)-240(3) to the hash LUT 270 according to their hierarchical order. For example, the change detection component 260 may first compare the hash value 204(1) to the hash LUT 270 to determine whether any changes have been made to the data asset 201. If the hash value 204(1) matches a known hash value in the LUT 270, the change detection component 260 may output data reuse information 205 indicating that embeddings can be reused for each of the data chunks 203 associated with the data asset 201. In other words, the data processing pipeline 200 does not need to generate any new embeddings for the current data asset 201.

If the hash value 204(1) does not match any known hash values in the LUT 270, the change detection component 260 may compare each of the hash value 204(2) to the LUT 270 to determine which of the semantic cells 202 have changed. If the hash value 204(2) for a given semantic cell 202 matches a known hash value in the LUT 270, the change detection component 260 may output data reuse information 205 indicating that embeddings can be reused for each of the data chunks 203 within the given semantic cell 202. In other words, the data processing pipeline 200 does not need to generate any new embeddings for the given semantic cell 202. However, if the hash value 204(2) for a given semantic cell 202 does not match any known hash values in the LUT 270, the change detection component 260 may compare a subset of the hash values 204(3) to the LUT 270 to determine which of the data chunks 203 within the given semantic cell 202 have changed. If the hash value for a given data chunk 203 matches a known hash value in the LUT 270, the change detection component 260 may output data reuse information 205 indicating that an embedding can be reused for the given data chunk 203. Otherwise, the change detection component 260 may output data reuse information 205 indicating that a new embedding must be generated for the given data chunk 204.

Aspects of the present disclosure recognize that, in rare circumstances, different data chunks can have the same hash value, which can lead to false positive detections of data reuse. In some implementations, the change detection component 260 may mitigate false detections by also comparing the length and/or content of each chunk 203 with the lengths and/or contents of previously processed chunks that map to existing embeddings in the vector repository 290 to determine whether a new embedding should be generated for a given data chunk 203. For example, the change detection component 260 may output data reuse information 205 indicating that an embedding can be reused for a given data chunk 203 only if the hash value for the data chunk 203 matches a known hash value in the LUT 270 and the length of the chunk 203 matches the length of the chunk associated with the known hash value. If either the hash value or the length of the chunk does not match, the change detection component 260 may output data reuse information 205 indicating that a new embedding must be generated for the given chunk 203.

The chunk filter 230 is configured to selectively output data chunks 203, as filtered chunks 206, to the vector mapping component 240 based on the data reuse information 205. More specifically, the filtered chunks 206 may include only such data chunks 203 for which new embeddings must be generated (such as indicated by the data reuse information 205). The vector mapping component 240 is configured to map each of the filtered chunks 206 to a new embedding 207. In some implementations, the vector mapping component 240 may perform the mapping based, at least in part, on a neural network model 208. For example, the filtered chunks 206 may be passed or otherwise processed through one or more embeddings layers of the neural network model 208 having outputs that result in the embeddings 207. In some implementations, the embeddings 207 may be stored in a vector repository 290. More specifically, the vector repository 290 may store or index the embeddings 207 in connection with the data chunks 203 to which they are mapped. For example, embeddings stored in the vector repository 290 may be identified by their associated hash values 204(3). This allows the stored embeddings to be reused when processing subsequent updates or revisions to the data asset 201.

In some implementations, the vector retrieval component 280 may retrieve and/or output the embedding IDs 209 for one or more embeddings stored in the vector repository 290 based on the data reuse information 205. For example, the data reuse information 205 may include the hash values 204(3) associated with each of the chunks 203. Thus, the vector retrieval component 280 may use the hash values 204(3) to look up the embedding IDs 209 in the vector repository 290. The embedding IDs 209 may point to any combination of existing embeddings and/or new embeddings 207 stored in the vector repository 290. Aspects of the present disclosure recognize that the ability to reuse existing embeddings enables the data processing pipeline 200 to quickly process updates or revisions for a previously processed data asset 201. Among other advantages, the data processing pipeline 200 of the present disclosure enables fine-grained detection of changes to the data asset 201, optimized use of processing and/or memory resources (which results in materially lower costs, reduced storage capacity requirements, and reduced processing times), and significantly faster time to value.

In the example of FIG. 2, the hash LUT 270 and the vector repository 290 are depicted as separate data repositories. However, in some implementations, the hash LUT 270 and the vector repository 290 may be combined into a single truth table (or set of truth tables) that can store hash information, vector embeddings, and any additional information (such as metadata) that may be relevant to other output data repositories that point to the truth table using the embedding IDs 209 (also referred to as “user tables” or “knowledge bases”). For example, the data processing pipeline 200 may store a single instance of each embedding 207 in the truth table (or set of truth tables), and one or more user tables may reference the embeddings stored in the truth table using the embedding IDs 209. In other words, user tables that would otherwise be used to store embeddings associated with a given data asset 201 may instead store embedding IDs 209 that point to such embeddings in the truth table (or set of truth tables).

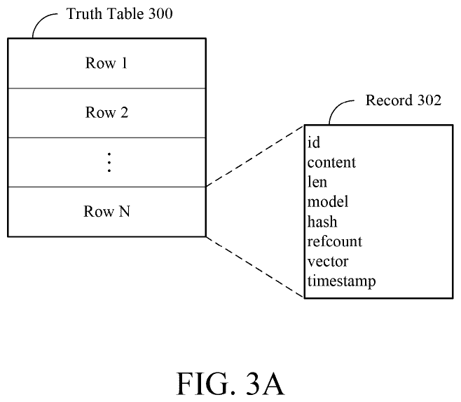

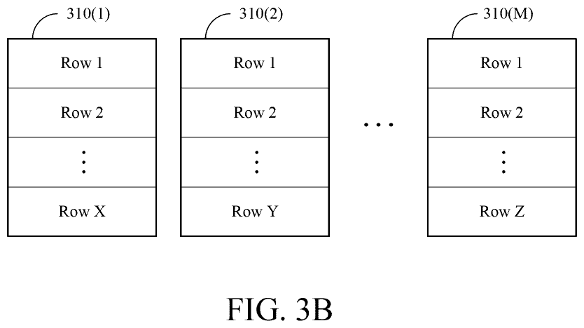

FIG. 3A shows an example truth table 300 for storing vector embeddings, according to some implementations. In some implementations, the truth table 300 may be one example of the vector repository 290 of FIG. 2. The truth table 300 includes a number (N) of rows each configured to store a respective record 302 of a vector embedding. More specifically, the truth table 300 may be configured to store N unique vector embeddings so that no two rows of the truth table 300 store the same embedding. With reference for example to FIG. 2, the vector mapping component 240 may store a respective record 302 in the truth table 300 for each new embedding 207 generated.

In the example of FIG. 3A, each record 302 is shown to include a row identifier (id) indicating the row of the truth table 300 in which the record 302 is stored, the raw data content that maps to the embedding (such as a chunk 203 of FIG. 2), a length (len) of the content, a neural network model associated with the embedding (such as the neural network model 208 of FIG. 2), a hash value associated with the content (such as a hash value 204(3) of FIG. 2), a number of references (refcount) to the embedding, the embedding (vector) itself, and a timestamp indicating when the embedding was created. In some other implementations, each record 302 may store less information than what is shown in FIG. 3A and/or other information in addition to or in lieu of what is shown in FIG. 3A.

FIG. 3B shows an example set of truth tables 310(1)-310(M) for storing vector embeddings, according to some implementations. In some of implementations, the truth tables 310(1)-310(M) may be one example of the vector repository 290 of FIG. 2. More specifically, the set of truth tables 310(1)-310(M) may be configured to store a number (N) of unique vector embeddings so that no duplicate embeddings are stored in or across any of the truth tables. For example, the truth table 310(1) may include a number (X) of rows configured to store a first subset of the N vector embeddings, the truth table 310(2) may include a number (Y) of rows configured to store a second subset of the N vector embeddings, and the truth table 310(M) may include a number (Z) of rows configured to store an M^{th} subset of the N vector embeddings. In some implementations, each row of a given truth table may store a respective record of a vector embedding (such as the record 302 of FIG. 3A).

In some aspects, each of the truth tables 310(1)-310(M) may store a set of vector embeddings with shared or similar characteristics. In some implementations, each of the truth tables 310(1)-310(M) may store a set of vector embeddings associated with hash values that share at least some characters in common. For example, the truth table 310(1) may store embeddings associated with hash values having “00” as the first two characters, the truth table 310(2) may store embeddings associated with hash values having “01” as the first two characters, and the truth table 310(M) may store embeddings associated with hash values having “ff” as the first two characters. By arranging the vector embeddings in different truth tables 310(1)-310(M) based on their associated hash values, aspects of the present disclosure can perform more granular searches of individual truth tables for matching hash values and/or embeddings, which can significantly reduce search and/or retrieval times.

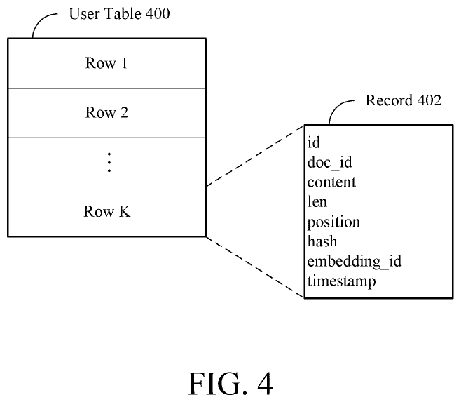

FIG. 4 shows an example user table 400 for aggregating embeddings associated with a data asset, according to some implementations. In some implementations, the user table 400 may be one example of any of the output data repositories 109 of FIG. 1. More specifically, the user table 400 may be used to retrieve a set of embeddings associated with a given data asset. The user table 400 includes a number (K) of rows each configured to store a respective record 402 of a vector embedding. However, instead of storing the embedding itself, each record 402 stores a pointer to the embedding in a truth table (such as the truth table 300 of FIG. 3A or the set of truth tables 310(1)-310(M) of FIG. 3B). With reference for example to FIG. 2, the vector retrieval component 280 may store a respective record 402 in the user table 400 for each embedding ID 209 output for the data asset 201.

In the example of FIG. 4, each record 402 is shown to include a row identifier (id) indicating the row of the user table 400 in which the record 402 is stored, a document identifier (docid) indicating the data asset with which the record 402 is associated, the raw data content that maps to the embedding (such as a chunk 203 of FIG. 2), a length (len) of the content, the ordinal position of the content relative to the data asset, a hash value associated with the content (such as a hash value 204(3) of FIG. 2), a pointer (embedding_id) to the embedding stored in a truth table (such as the embedding ID 209 of FIG. 2), and a timestamp indicating when the embedding was created. In some other implementations, each record 302 may store less information than what is shown in FIG. 3A and/or other information in addition to or in lieu of what is shown in FIG. 3A.

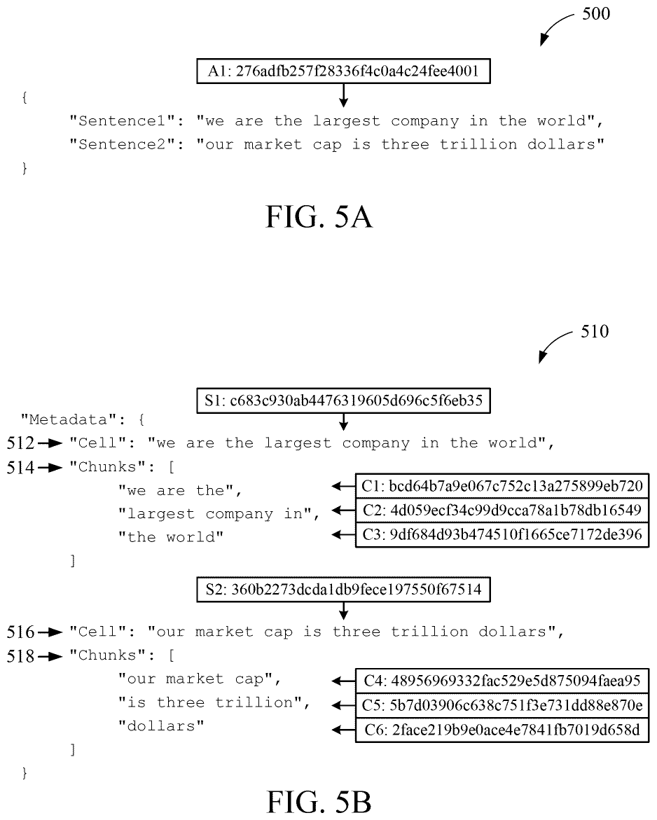

FIG. 5A shows an example data asset 500. In the example of FIG. 5A, the data asset 500 is depicted as a JavaScript Object Notation (JSON) file. More specifically, the data asset 500 includes the text (or token) stream: “Sentence 1 we are the largest company in the world Sentence 2 our market cap is three trillion dollars.” In some aspects, the data asset 500 may be processed or otherwise mapped to one or more vector embeddings (not shown for simplicity) by a data processing pipeline. With reference to FIGS. 1 and 2, the data asset 500 may be one example of any of the data assets 102 and/or 201 and the data processing pipeline may be one example of any of the data processing pipelines 120 and/or 200. In some implementations, the data processing pipeline may map the data asset 500 to a hash value (A1) for purposes of detecting changes or updates to the data asset 500 (such as described with reference to FIGS. 1 and 2). With reference to FIG. 2, the hash value A1 may be one example of the hash value 204(1) associated with the data asset 201. As shown in FIG. 5A, the hash value A1 is an MD5 hash value equal to “276adfb257f28336f4c0a4c24fee4001.”

FIG. 5B shows example metadata 510 that can be extracted from the data asset 500 of FIG. 5A, according to some implementations. In some implementations, the metadata 510 may be extracted by a data processing pipeline (such as any of the data processing pipelines 120 or 200 of FIGS. 1 and 2, respectively). More specifically, the metadata 510 may be extracted by the semantic cell extraction component 210 and the chunking component 220 of FIG. 2. As shown in FIG. 5B, the metadata 510 includes multiple semantic cells 512 and 516 that are further subdivided into data chunks 514 and 518, respectively. With reference to FIG. 2, each of the semantic cells 512 and 516 may be one example of the semantic cells 202 and each of the data chunks 514 and 518 may be one example of the data chunk 203. In the example of FIG. 5B, each of the semantic cells 512 and 516 represents a respective sentence in the content item 500 and each data chunk represents a grouping of up to 3 consecutive words (or tokens) within a given semantic cell.

In some implementations, the data processing pipeline may map the metadata 510 to a set of hash values for purposes of detecting granular changes to the data asset 500 (such as described with reference to FIGS. 1 and 2). More specifically, the data processing pipeline may map each of the semantic cells 512 and 516 to respective hash values (S1 and S2) and may further map each of the data chunks 514 and 518 to respective hash values (C1-C3 and C4-C6). With reference to FIG. 2, the hash values S1 and S2 may be examples of the hash values 204(2) associated with the semantic cells 202, and the hash values C1-C6 may be examples of the hash values 204(3) associated with the data chunks 203. In the example of FIG. 5B, each of the hash values S1, S2 and C1-C6 is associated with an MD5 hash function having the following values:

```
□ S1 = “c683c930ab4476319605d696c5f6eb35”
  ∘ C1 = “bcd64b7a9e067c752c13a275899eb720”
  ∘ C2 = “4d059ecf34c99d9cca78a1b78db16549”
  ∘ C3 = “9df684d93b474510f1665ce7172de396”
□ S2 = “360b2273dcda1db9fece197550f67514”
  ∘ C4 = “48956969332fac529e5d875094faea95”
  ∘ C5 = “5b7d03906c638c751f3e731dd88e870e”
  ∘ C6 = “2face219b9e0ace4e7841fb7019d658d”
```

In some implementations, the data processing pipeline mare compare the hash values A1, S1, S2, and C1-C6 against a lookup table of known hash values (such as the hash LUT 270 of FIG. 2) to detect changes or updates to the data asset 500 at different levels of granularity. For example, the data processing pipeline may use the hash values A1, S1, S2, and/or C1-C6 to quickly determine whether the data asset 500, or any of the semantic cells 512 and 516 and/or data chunks 514 and 518, has been previously mapped to embeddings that can be reused by the data processing pipeline in lieu of generating new embeddings for such data. In some aspects, the hash values A1, S1, S2, and C1-C6 may be further stored in the lookup table for purposes of detecting subsequent changes or updates to the data asset 500.

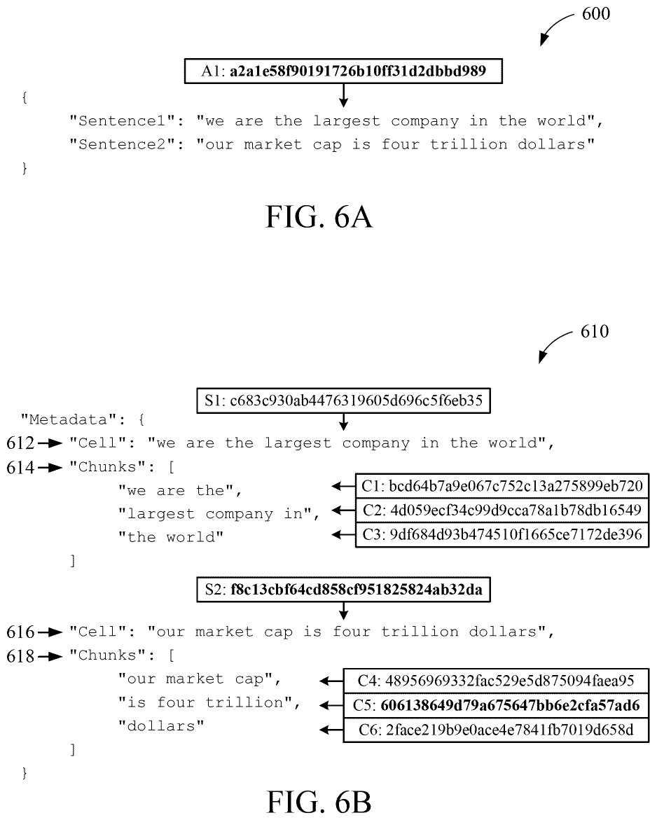

FIG. 6A shows another example data asset 600. In the example of FIG. 6A, the data asset 600 is depicted as a JSON file. More specifically, the data asset 600 includes the text (or token) stream: “Sentence 1 we are the largest company in the world Sentence 2 our market cap is four trillion dollars.” In some aspects, the data asset 600 may be processed or otherwise mapped to one or more vector embeddings (not shown for simplicity) by a data processing pipeline after processing the data asset 500 of FIG. 5A. With reference to FIGS. 1 and 2, the data asset 600 may be one example of any of the data assets 102 and/or 201 and the data processing pipeline may be one example of any of the data processing pipelines 120 and/or 200. In some implementations, the data processing pipeline may map the data asset 600 to a hash value (A1) for purposes of detecting changes or updates to the data asset 600 (such as described with reference to FIGS. 1 and 2). As shown in FIG. 6A, the hash value A1 is an MD5 hash value equal to “a2a1e58f90191726b10ff31d2dbbd989.”

FIG. 6B shows example metadata 610 that can be extracted from the data asset 600 of FIG. 6A, according to some implementations. In some implementations, the metadata 610 may be extracted by a data processing pipeline (such as any of the data processing pipelines 120 or 200 of FIGS. 1 and 2, respectively). More specifically, the metadata 610 may be extracted by the semantic cell extraction component 210 and the chunking component 220 of FIG. 2. As shown in FIG. 6B, the metadata 610 includes multiple semantic cells 612 and 616 that are further subdivided into data chunks 614 and 618, respectively. With reference to FIG. 2, each of the semantic cells 612 and 616 may be one example of the semantic cells 202 and each of the data chunks 614 and 618 may be one example of the data chunk 203. In the example of FIG. 6B, each of the semantic cells 612 and 616 represents a respective sentence in the content item 500 and each data chunk represents a grouping of up to 3 consecutive words (or tokens) within a given semantic cell.

In some implementations, the data processing pipeline may map the metadata 610 to a set of hash values for purposes of detecting granular changes to the data asset 600 (such as described with reference to FIGS. 1 and 2). More specifically, the data processing pipeline may map each of the semantic cells 612 and 616 to respective hash values (S1 and S2) and may further map each of the data chunks 614 and 618 to respective hash values (C1-C3 and C4-C6). In the example of FIG. 6B, each of the hash values S1, S2 and C1-C6 is associated with an MD5 hash function having the following values:

```
□ S1 = “c683c930ab4476319605d696c5f6eb35”
  ∘ C1 = “bcd64b7a9e067c752c13a275899eb720”
  ∘ C2 = “4d059ecf34c99d9cca78a1b78db16549”
  ∘ C3 = “9df684d93b474510f1665ce7172de396”
□ S2 = “f8c13cbf64cd858cf951825824ab32da”
  ∘ C4 = “48956969332fac529e5d875094faea95”
  ∘ C5 = “606138649d79a675647bb6e2cfa57ad6”
  ∘ C6 = “2face219b9e0ace4e7841fb7019d658d”
```

In some implementations, the data processing pipeline may compare the hash values A1, S1, S2, and C1-C6 associated with the metadata 610 against a lookup table of known hash values, which includes the hash values A1, S1, S2, and C1-C6 associated with the metadata 510, to detect changes or updates to the data asset 600 at different levels of granularity. More specifically, the data processing pipeline may analyze each of the hash values A1, S1, S2, and C1-C6 associated with the metadata 610, in hierarchical order, beginning with the hash value A1 representing the data asset 600 as a whole. For example, the data processing pipeline may first determine that the hash value A1 does not match any known hash values stored in the lookup table. Accordingly, the data processing pipeline may proceed to analyze the hash values S1 and S2 representing the semantic cells 612 and 616.

As shown in FIG. 6B, the data processing pipeline may determine that the hash value S1 representing the semantic cell 612 matches the hash value S1 representing the semantic cell 512. Accordingly, the data processing pipeline may reuse any embeddings mapped to the semantic cell 512 as corresponding embeddings for the semantic cell 612 (such as embeddings generated for the data chunks: “we are the,” “largest company in,” and “the world”). In some implementations, the data processing pipeline may retrieve such embeddings from a vector repository (such as the vector repository 290 of FIG. 2). Because a match is detected at the semantic cell level, the data processing pipeline does not need to analyze any of the hash values C1-C3 associated with the data chunks 614 for matches in the lookup table.

The data processing pipeline may further determine that the hash value S2 representing the semantic cell 616 does not match any known hash values stored in the lookup table. Accordingly, the data processing pipeline may proceed to analyze the hash values C4-C6 representing the data chunks 618 within the semantic cell 616. As shown in FIG. 6B, the data processing pipeline may determine that the hash values C4 and C6 associated with the metadata 610 match the hash values C4 and C6 associated with the metadata 510. Accordingly, the data processing pipeline may reuse existing embeddings that have already been mapped to the data chunks: “our market cap” and “dollars.” However, the data processing pipeline also may determine that the hash value C5 associated with the metadata 610 does not match any known hash values stored in the lookup table. Accordingly, the data processing pipeline may generate a new embedding for the data chunk: “is four trillion.”

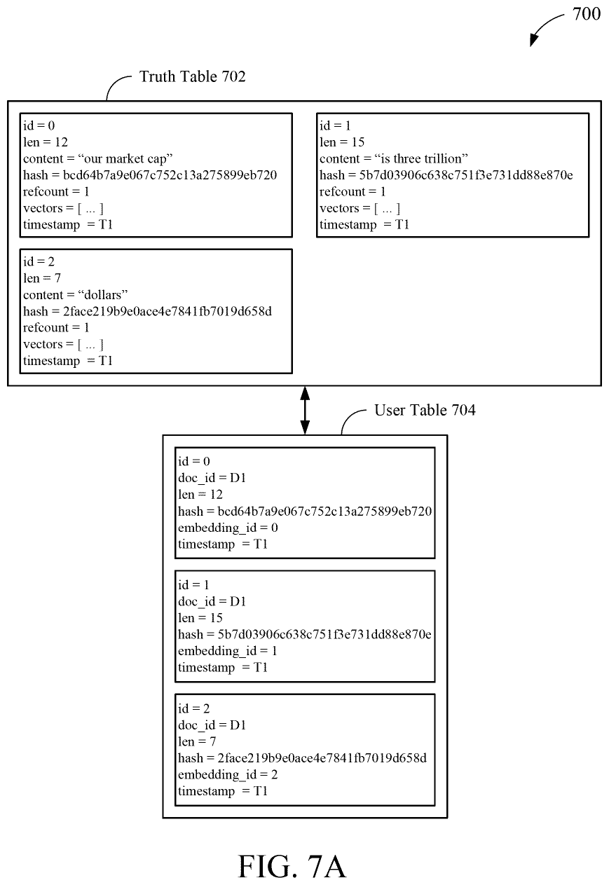

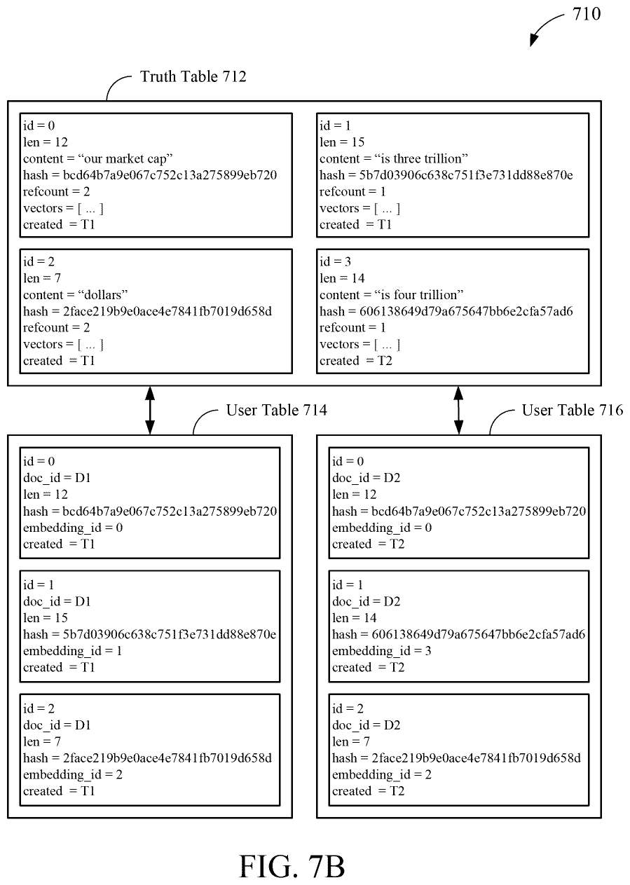

FIG. 7A shows an example relational database 700 including a truth table 702 and a user table 704, according to some implementations. In some implementations, the truth table 702 may be one example of the truth table 300 of FIG. 3A or the set of truth tables 310(1)-310(M) of FIG. 3B. In some implementations, the user table 704 may be one example of the user table 400 of FIG. 4. With reference for example to FIG. 5A, the truth table 702 is shown to store a set of embeddings generated for the data asset 500. However, only the embeddings representing the data chunks 518 of FIG. 5B are depicted in the example of FIG. 7A.

The truth table 702 includes at least 3 rows, having row identifiers (id) 0-2, each configured to store a respective record of a vector embedding. With reference for example to FIG. 3A, each row of the truth table 702 may store a respective record 302. As shown in FIG. 7A, the first record (id=0) of the truth table 702 includes a vector embedding, generated at time T1, representing “our market cap” and having a reference count equal to 1 (which indicates that the embedding is referenced by exactly 1 user table). The second record (id=1) of the truth table 702 includes a vector embedding, generated at time T1, representing “is three trillion” and having a reference count equal 1. The third record (id=2) of the truth table 702 includes a vector embedding, generated at time T1, representing “dollars” and having a reference count equal to 1.

The user table 704 includes at least 3 rows, having row identifiers (id) 0-2, each configured to store a respective record pointing to a vector embedding in the truth table 702. With reference for example to FIG. 4, each row of the user table 704 may store a respective record 402. As shown in FIG. 7A, the first record (id=0) of the user table 704 includes a pointer (embedding_id=0) to the first record of the truth table 702 (which stores the embedding representing “our market cap”), generated at time T1, for a given data asset (doc_id=D1). The second record (id=1) of the user table 704 includes a pointer (embedding_id=1) to the second record of the truth table 702 (which stores the embedding representing “is three trillion”), generated at time T1, for the given data asset. The third record (id=2) of the user table 704 includes a pointer (embedding_id=2) to the third record of the truth table 702 (which stores the embedding representing “dollars”), generated at time T1, for the given data asset.

FIG. 7B shows an example relational database 710 including a truth table 712 and multiple user tables 714 and 716, according to some implementations. In some implementations, the truth table 712 may be one example of the truth table 300 of FIG. 3A or the set of truth tables 310(1)-310(M) of FIG. 3B. In some implementations, each of the user tables 714 and 716 may be one example of the user table 400 of FIG. 4. With reference for example to FIGS. 5A and 6A, the truth table 702 is shown to store a set of embeddings generated for the data assets 500 and 600, respectively. However, only the embeddings representing the data chunks 518 and 618 of FIG. 5B and FIG. 6B, respectively, are depicted in the examples of FIG. 7A.

The truth table 712 includes at least 4 rows, having row identifiers (id) 0-3, each configured to store a respective record of a vector embedding. With reference for example to FIG. 3A, each row of the truth table 712 may store a respective record 302. As shown in FIG. 7B, the first record (id=0) of the truth table 712 includes a vector embedding, generated at time T1, representing “our market cap” and having a reference count equal to 2 (which indicates that the embedding is referenced by exactly 2 user tables). The second record (id=1) of the truth table 712 includes a vector embedding, generated at time T1, representing “is three trillion” and having a reference count equal 1. The third record (id=2) of the truth table 712 includes a vector embedding, generated at time T1, representing “dollars” and having a reference count equal to 2. The fourth record (id=3) of the truth table 712 includes a vector embedding, generated at time T2, representing “is four trillion” and having a reference count equal to 1.

The user table 714 includes at least 3 rows, having row identifiers (id) 0-2, each configured to store a respective record pointing to a vector embedding in the truth table 712. With reference for example to FIG. 4, each row of the user table 714 may store a respective record 402. As shown in FIG. 7B, the first record (id=0) of the user table 714 includes a pointer (embedding_id=0) to the first record of the truth table 712 (which stores the embedding representing “our market cap”), generated at time T1, for a given data asset (doc_id=D1). The second record (id=1) of the user table 714 includes a pointer (embedding_id=1) to the second record of the truth table 712 (which stores the embedding representing “is three trillion”), generated at time T1, for the given data asset. The third record (id=2) of the user table 714 includes a pointer (embedding_id=2) to the third record of the truth table 712 (which stores the embedding representing “dollars”), generated at time T1, for the given data asset.

The user table 716 includes at least 3 rows, having row identifiers (id) 0-2, each configured to store a respective record pointing to a vector embedding in the truth table 712. With reference for example to FIG. 4, each row of the user table 716 may store a respective record 402. As shown in FIG. 7B, the first record (id=0) of the user table 716 includes a pointer (embedding_id=0) to the first record of the truth table 712 (which stores the embedding representing “our market cap”), generated at time T2, for a given data asset (doc_id=D2). The second record (id=1) of the user table 716 includes a pointer (embedding_id=3) to the second record of the truth table 712 (which stores the embedding representing “is three trillion”), generated at time T2, for the given data asset. The third record (id=2) of the user table 716 includes a pointer (embedding_id=2) to the third record of the truth table 712 (which stores the embedding representing “dollars”), generated at time T2, for the given data asset.

In the example of FIG. 7B, the user table 716 may be created after the user table 714 (T2>T1). Because the truth table 712 already stores embeddings associated with the data asset D2, the user table 716 can reuse the existing embeddings stored in the first record (id=0) and the third record (id=2) of the truth table 712. The reference count associated with such embeddings can be incremented (from 1 to 2) in response to the first record (id=0) and the third record (id=2) of the user table 716 pointing to the embeddings. When a record is deleted or removed from a user table, the truth table 712 may decrement the reference count for the embedding to which the deleted record points. If the resulting reference count is equal to 0, the corresponding record may be deleted or removed from the truth table 712. For example, if the user table 716 is subsequently deleted from a set of output data repositories, the reference counts associated with the first record (id=0), the third record (id=2), and the fourth record (id=3) of the truth table 712 may be decremented in response to deleting the user table 716. Because no other user table points to the embedding representing “is four million,” the fourth record (id=3) of the truth table 712 may be deleted or removed. In other words, the resulting truth table 712 may appear the same as the truth table 702 of FIG. 7A.

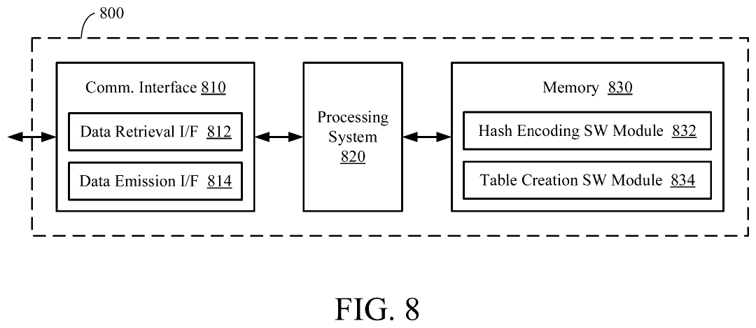

FIG. 8 shows a block diagram of an example data processing pipeline 800, according to some implementations. In some implementations, the data processing pipeline 800 may be one example of any of the data processing pipelines 120 or 200 of FIGS. 1 and 2, respectively. More specifically, the data processing pipeline 800 is configured to map a data asset to a set of vector embeddings.

The processing pipeline 800 includes a communication interface 810, a processing system 820, and a memory 830. The communication interface 810 is configured to communicate with one or more data repositories. More specifically, the communication interface 810 includes a data retrieval interface (I/F) 812 for communicating with one or more input data repositories (such as the input data repositories 101 of FIG. 1) and a data emission interface (I/F) 814 for communicating with one or more output data repositories (such as the output data repositories 109 of FIG. 1). In some implementations, the data retrieval interface 812 may receive a data asset.

The memory 830 includes a non-transitory computer-readable medium (including one or more nonvolatile memory elements, such as EPROM, EEPROM, Flash memory, or a hard drive, among other examples) that can store the following software (SW) modules: a hash encoding SW module 832 to map the data asset to one or more hash values; and a table creation SW module 834 to create a user table for the data asset based at least in part on the one or more hash values, where the user table includes one or more pointers that point to one or more records stored in a vector repository, respectively, where each record of the one or more records includes a vector embedding and a hash value associated therewith that matches a respective hash value of the one or more hash values.

The processing system 820 includes any suitable one or more processors capable of executing scripts or instructions of one or more software programs stored in the data processing pipeline 800 (such as in the memory 830). For example, the processing system 820 can execute the hash encoding SW module 832 to map the data asset to one or more hash values. The processing system 820 can further execute the table creation SW module 834 to create a user table for the data asset based at least in part on the one or more hash values, where the user table includes one or more pointers that point to one or more records stored in a vector repository, respectively, where each record of the one or more records includes a vector embedding and a hash value associated therewith that matches a respective hash value of the one or more hash values.

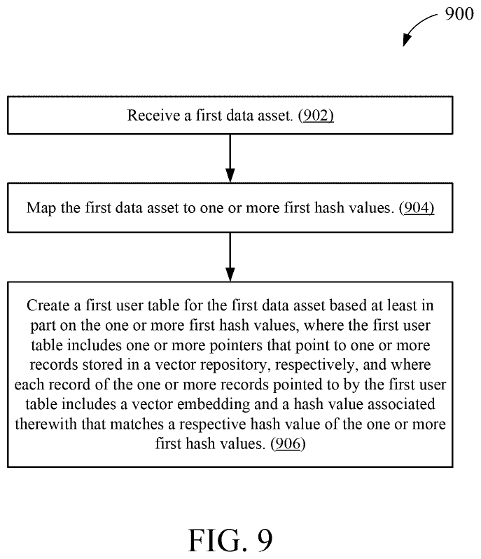

FIG. 9 shows an illustrative flowchart depicting an example operation 900 for processing data, according to some implementations. In some implementations, the example operation 900 may be performed by a data processing pipeline such as the data processing pipeline 800 of FIG. 8.

The data processing pipeline receives a first data asset (902). The data processing pipeline maps the first data asset to one or more first hash values (904). The data processing pipeline creates a first user table for the first data asset based at least in part on the one or more first hash values, where the first user table includes one or more pointers that point to one or more records stored in a vector repository, respectively, where each record of the one or more records pointed to by the first user table includes a vector embedding and a hash value associated therewith that matches a respective hash value of the one or more first hash values (906). In some implementations, the vector embedding included in each record may be associated with a neural network model.

In some implementations, the one or more records may be arranged in a plurality of truth tables based at least in part on the hash value associated with each record. In some implementations, each record of the one or more records may further include raw data content that maps to the hash value associated therewith or a length of the raw data content. In some implementations, each record of the one or more records may further include a timestamp indicating when the record was created or a number of references to the respective vector embedding, where the number of references indicates a total number of pointers that point to the record.

In some aspects, the data processing pipeline may further determine whether the one or more first hash values match any hash values previously stored in the vector repository and selectively create one or more new records in the vector repository based at least in part on whether the one or more first hash values match any of the hash values previously stored in the vector repository. In some implementations, the selective creating of a new record in the vector repository may include mapping the first data asset to one or more new vector embeddings responsive to determining that at least one of the one or more first hash values does not match any of the hash values previously stored in the vector repository, and creating one or more new records in the vector repository that include the one or more new vector embeddings, respectively.

In some other implementations, the selective creating of a new record in the vector repository may include determining whether any portions of the first data asset that map to the one or more first hash values match any raw data content previously stored in the vector repository; mapping the first data asset to one or more new vector embeddings responsive to determining that at least one of the portions of the first data asset does not match any of the raw data content previously stored in the vector repository; and creating one or more new records in the vector repository that include the one or more new vector embeddings, respectively.

In some other implementations, the selective creating of a new record in the vector repository may include determining whether a length of any portions of the first data asset that map to the one or more first hash values match a length of any raw data content previously stored in the vector repository; mapping the first data asset to one or more new vector embeddings responsive to determining that the length of at least one of the portions of the first data asset does not match the length of any of the raw data content previously stored in the vector repository; and creating one or more new records in the vector repository that include the one or more new vector embeddings, respectively.

In some aspects, the data processing pipeline may further receive a second data asset; map the second data asset to one or more second hash values; and create a second user table for the second data asset based at least in part on the one or more second hash values, where the second user table includes one or more pointers that point to one or more records stored in the vector repository, respectively, where each record of the one or more records pointed to by the second user table includes a vector embedding and a hash value associated therewith that matches a respective hash value of the one or more second hash values. In some implementations, at least one pointer of the one or more pointers in the second user table may point to the same record in the vector repository as at least one pointer of the one or more pointers in the first user table.

In some implementations, the data processing pipeline may further increment the number of references for the record pointed to by at least one pointer in the first user table and at least one pointer in the second user table. In some implementations, the data processing pipeline may further delete the second user table and decrement the number of references for each record of the one or more records in the vector repository pointed to by the second user table responsive to deleting the second user table. In some implementations, the data processing pipeline may further determine that the number of references is equal to zero for a first record of the one or more records in the vector repository pointed to by the second user table, and delete the first record from the vector repository responsive to determining that the number of references for the first record is equal to zero.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for processing data, comprising:
receiving a first data asset;
mapping the first data asset to one or more first hash values; and
creating a first user table for the first data asset based at least in part on the one or more first hash values, the first user table including one or more pointers that point to one or more records stored in a vector repository, respectively, each record of the one or more records pointed to by the first user table including a vector embedding and a hash value associated therewith that matches a respective hash value of the one or more first hash values.

2. The method of claim 1, wherein the vector embedding included in each record is associated with a neural network model.

3. The method of claim 1, wherein the one or more records are arranged in a plurality of truth tables based at least in part on the hash value associated with each record.

4. The method of claim 1, wherein each record of the one or more records further includes raw data content that maps to the hash value associated therewith or a length of the raw data content.

5. The method of claim 4, further comprising:
determining whether the one or more first hash values match any hash values previously stored in the vector repository; and
selectively creating one or more new records in the vector repository based at least in part on whether the one or more first hash values match any of the hash values previously stored in the vector repository.

6. The method of claim 5, wherein the selective creating of a new record in the vector repository comprises:
mapping the first data asset to one or more new vector embeddings responsive to determining that at least one of the one or more first hash values does not match any of the hash values previously stored in the vector repository; and
creating one or more new records in the vector repository that include the one or more new vector embeddings, respectively.

7. The method of claim 5, wherein the selective creating of a new record in the vector repository comprises:
determining whether any portions of the first data asset that map to the one or more first hash values match any raw data content previously stored in the vector repository;
mapping the first data asset to one or more new vector embeddings responsive to determining that at least one of the portions of the first data asset does not match any of the raw data content previously stored in the vector repository; and
creating one or more new records in the vector repository that include the one or more new vector embeddings, respectively.

8. The method of claim 5, wherein the selective creating of a new record in the vector repository comprises:
determining whether a length of any portions of the first data asset that map to the one or more first hash values match a length of any raw data content previously stored in the vector repository;
mapping the first data asset to one or more new vector embeddings responsive to determining that the length of at least one of the portions of the first data asset does not match the length of any of the raw data content previously stored in the vector repository; and
creating one or more new records in the vector repository that include the one or more new vector embeddings, respectively.

9. The method of claim 1, wherein each record of the one or more records further includes a timestamp indicating when the record was created or a number of references to the respective vector embedding, the number of references indicating a total number of pointers that point to the record.

10. The method of claim 9, further comprising:
receiving a second data asset;
mapping the second data asset to one or more second hash values; and
creating a second user table for the second data asset based at least in part on the one or more second hash values, the second user table including one or more pointers that point to one or more records stored in the vector repository, respectively, each record of the one or more records pointed to by the second user table including a vector embedding and a hash value associated therewith that matches a respective hash value of the one or more second hash values.

11. The method of claim 10, wherein at least one pointer of the one or more pointers in the second user table points to the same record in the vector repository as at least one pointer of the one or more pointers in the first user table.

12. The method of claim 11, further comprising:
incrementing the number of references for the record pointed to by at least one pointer in the first user table and at least one pointer in the second user table.

13. The method of claim 10, further comprising:
deleting the second user table; and
decrementing the number of references for each record of the one or more records in the vector repository pointed to by the second user table responsive to deleting the second user table.

14. The method of claim 13, further comprising:
determining that the number of references is equal to zero for a first record of the one or more records in the vector repository pointed to by the second user table; and
deleting the first record from the vector repository responsive to determining that the number of references for the first record is equal to zero.

15. A data processing pipeline comprising:
a processing system; and
a memory storing instructions that, when executed by the processing system, causes the data processing pipeline to:
receive a first data asset;
map the first data asset to one or more first hash values; and
create a first user table for the first data asset based at least in part on the one or more first hash values, the first user table including one or more pointers that point to one or more records stored in a vector repository, respectively, each record of the one or more records pointed to by the first user table including a vector embedding and a hash value associated therewith that matches a respective hash value of the one or more first hash values.

16. The data processing pipeline of claim 15, wherein the one or more records are arranged in a plurality of truth tables based at least in part on the hash value associated with each record.

17. The data processing pipeline of claim 15, wherein each record of the one or more records further includes raw data content that maps to the hash value associated therewith, a length of the raw data content, a timestamp indicating when the record was created, or a number of references to the respective vector embedding, the number of references indicating a total number of pointers that point to the record.

18. The data processing pipeline of claim 15, wherein execution of the instructions further causes the data processing pipeline to:
determine whether the one or more first hash values match any hash values previously stored in the vector repository; and
selectively create one or more new records in the vector repository based at least in part on whether the one or more first hash values match any of the hash values previously stored in the vector repository.

19. The data processing pipeline of claim 15, wherein execution of the instructions further causes the data processing pipeline to:
receive a second data asset;
map the second data asset to one or more second hash values; and
create a second user table for the second data asset based at least in part on the one or more second hash values, the second user table including one or more pointers that point to one or more records stored in the vector repository, respectively, each record of the one or more records pointed to by the second user table including a vector embedding and a hash value associated therewith that matches a respective hash value of the one or more second hash values.

20. The data processing pipeline of claim 19, wherein at least one pointer of the one or more pointers in the second user table points to the same record in the vector repository as at least one pointer of the one or more pointers in the first user table.
